(19) United States
(12) Patent Application Publication
(10) Pub. No.: US 2003/0043852 A1
(43) Pub. Date: Mar. 6, 2003

(54) Method and apparatus for verifying data integrity based on data compression parameters

(76) Inventors: Bijan Tadayon, Germantown, MD (US); Aram Nahidipour, Laguna Niguel, CA (US); Michael Raley, Downey, CA (US); Guillermo Lao, Torrance, CA (US); Charles Gilliam, Darien, CT (US); Thanh Ta, Huntington Beach, CA (US)

Correspondence Address: NIXON PEABODY, LLP, 8180 GREENSBORO DRIVE, SUITE 800, MCLEAN, VA, 22102, US

(21) Appl. No.: 10/147,304

(22) Filed: May 17, 2002

Related U.S. Application Data
(60) Provisional application No. 60/291,629, filed on May 18, 2001.

(51) Int. Cl. H04L 9/00

(52) U.S. Cl. 370/477; 370/252

(57) ABSTRACT

A method and apparatus for verifying data integrity. A compression parameter, such as the average code length of compressed data, is obtained. The parameter is transmitted to a recipient of the data to permit the recipient to again determine the parameter and compare the value of the parameter to the originally determined value. If the value of the parameter has changed, the data may have been modified or otherwise manipulated.

### RELATED APPLICATION DATA

This application claims the benefit of pending U.S. provisional application Ser. No. 60/291,629 filed on May 18, 2001, the disclosure of which is incorporated herein by reference.

### BACKGROUND

This application relates generally to data integrity and more specifically to a method and apparatus for verifying data integrity by using parameters obtained from compression of the data.

The security of electronic data, such as data transmitted over computer networks, has become increasingly important. For example, the increase in “eCommerce”, i.e. the transaction of business over the Internet and other computer networks, has resulted in a tremendous amount of confidential, or otherwise important, data being transmitted electronically. Accordingly, it is important to maintain the security of such data. One component of security is the verification of the integrity of the data. In other words, it is important to minimize the possibility that someone has altered the data. Various methods, such as check sums, parity bits, and hash techniques, have been used to ensure data integrity. However, known integrity checking techniques require additional processing and thus increase computing overhead. Further, known techniques are not “hackproof”, i.e. can be circumvented.

In order to reduce overhead and data transmission speeds, it is known to utilize data compression techniques. In particular, coding redundancy is present in many data files or portions thereof. “Variable length” coding techniques are well known for compressing data, such as image files and other types of data. For efficient compression, the goal is to assign the shortest possible code words to the most probable gray levels, or other symbols in the source data, i.e., the data to be compressed. That is, one wants to get the smallest possible number of code symbols per symbol in the source data. One popular technique for reducing coding redundancy is known as “Huffman” coding. Other similar techniques are “Truncated Huffman”, “B2-Code”, “Binary Shift”, and “Huffman Shift.” These techniques, and the corresponding algorithms, are well known. For example, the book entitled “Digital Image Processing”, published by Addison-Wesley Publishing Company in 1992, describes these techniques, at pages 343-348.

Tables 1 and 2 below illustrate an example of the basic premise of Huffman coding. As shown in Table 1, symbols and their corresponding probabilities of occurrence within a source data file are listed in decreasing order of their probabilities. The two lowest probabilities are combined, i.e. added, to yield a new probability, which is placed in column 1 of Table 1, along with the other probabilities in decreasing order of the probabilities. This reduction is continued until only the last two probabilities are left, as shown in column 4 of Table 1.

Then, as shown in Table 2, the codes of the compressed data corresponding to the source data are generated based on the Huffman code assignment procedure, in the reverse order that columns of Table 1 were generated (i.e., starting at column 4, proceeding through each column to column 1, and ending at the column titled “Probability”). First, under column 4, a zero and a one are assigned to the probabilities to distinguish them from each other. Then, under column 3, a zero and a one are added to the codes corresponding to 0.3 probability to distinguish them from each other. Similar additions continue in order toward the columns to the left. The codes corresponding to the column titled “Probability” are the final codes which are used to construct the compressed data in a known manner and are listed in the “Code” column. One can easily determine the average length of the final codes from Table 2.

TABLE 1

| Symbol | Probability | 1 | 2 | 3 | 4 |
|---|---|---|---|---|---|
| a₂ | 0.4 | 0.4 | 0.4 | 0.4 | 0.6 |
| a₆ | 0.3 | 0.3 | 0.3 | 0.3 | 0.4 |
| a₁ | 0.1 | 0.1 | 0.2 | 0.3 | |
| a₄ | 0.1 | 0.1 | 0.1 | | |
| a₃ | 0.06 | 0.1 | | | |
| a₅ | 0.04 | | | | |

TABLE 2

| | Proba- | | | | | | | | | |
|---|---|---|---|---|---|---|---|---|---|---|
| Symbol | bility | Code | 1 | | 2 | | 3 | | 4 | |
| a₂ | 0.4 | 1 | 0.4 | 1 | 0.4 | 1 | 0.4 | 1 | 0.6 | 0 |
| a₆ | 0.3 | 00 | 0.3 | 00 | 0.3 | 00 | 0.3 | 00 | 0.4 | 1 |
| a₁ | 0.1 | 011 | 0.1 | 011 | 0.2 | 010 | 0.3 | 01 | | |
| a₄ | 0.1 | 0100 | 0.1 | 0100 | 0.1 | 011 | | | | |
| a₃ | 0.06 | 01010 | 0.1 | 0101 | | | | | | |
| a₅ | 0.04 | 01011 | | | | | | | | |

The average length of a code corresponding to a symbol is the summation of a given probability of a symbol times the length of its corresponding code, expressed, for example, in the number of bits.

For the example of Tables 1 and 2, this yields:

L_{average}=[(0.04×5)+(0.06×5)+(0.1×4)+(0.1×3)+(0.3×2)+(0.4×1)]

L_{average}=2.2bits/symbol

Note that the average number of bits per symbol is reduced, as compared to the source data, when the Huffman technique is applied to thereby achieve data compression. Table 3 below lists some of the various other techniques of variable length code data compression. Note that the source symbols are again ordered based on their corresponding probabilities. The Huffman Shift technique is similar to Huffman for Block 1 of the probability list. However, for Blocks 2 and 3, zeros are added to the left, to make them distinguishable and unique, compared to the codes of Block 1. As can be seen from Table 3, the average length for Huffman Shift code in this example (4.13) is larger than the average length of Huffman code in this example (4.05). Thus, the Huffman technique yields better compression than the Huffman Shift technique. However, the Huffman Shift technique is easier to execute.

TABLE 3

| Source | | Binary | | Truncated | | Binary | Huffman |
|---|---|---|---|---|---|---|---|
| Symbol | Prob. | Code | Huffman | Huffman | B2-Code | Shift | Shift |
| Block 1 | | | | | | | |
| a1 | 0.2 | 00000 | 10 | 11 | C00 | 000 | 10 |
| a2 | 0.1 | 00001 | 110 | 011 | C01 | 001 | 11 |
| a3 | 0.1 | 00010 | 111 | 0000 | C10 | 010 | 110 |
| a4 | 0.06 | 00011 | 0101 | 0101 | C11 | 011 | 100 |
| a5 | 0.05 | 00100 | 00000 | 00010 | C00C00 | 100 | 101 |
| a6 | 0.05 | 00101 | 00001 | 00011 | C00C01 | 101 | 1110 |
| a7 | 0.05 | 00110 | 00010 | 00100 | C00C10 | 110 | 1111 |
| Block 2 | | | | | | | |
| a8 | 0.04 | 00111 | 00011 | 00101 | C00C11 | 111000 | 0010 |
| a9 | 0.04 | 01000 | 00110 | 00110 | C01C00 | 111001 | 0011 |
| a10 | 0.04 | 01001 | 00111 | 00111 | C01C01 | 111010 | 00110 |
| a11 | 0.04 | 01010 | 00100 | 01000 | C01C10 | 111011 | 00100 |
| a12 | 0.03 | 01011 | 01001 | 01001 | C01C11 | 111100 | 00101 |
| a13 | 0.03 | 01100 | 01110 | 100000 | C10C00 | 111101 | 001110 |
| a14 | 0.03 | 01101 | 01111 | 100001 | C10C01 | 111110 | 001111 |
| Block 3 | | | | | | | |
| a15 | 0.03 | 01110 | 01100 | 100010 | C10C10 | 111111000 | 000010 |
| a16 | 0.02 | 01111 | 010000 | 100011 | C10C11 | 111111001 | 000011 |
| a17 | 0.02 | 10000 | 010001 | 100100 | C11C00 | 111111010 | 0000110 |
| a18 | 0.02 | 10001 | 001010 | 100101 | C11C01 | 111111011 | 0000100 |
| a19 | 0.02 | 10010 | 001011 | 100110 | C11C10 | 111111100 | 0000101 |
| a20 | 0.02 | 10011 | 011010 | 100111 | C11C11 | 111111101 | 00001110 |
| a21 | 0.01 | 10100 | 011011 | 101000 | C00C00C00 | 111111110 | 00001111 |
| Average | | 5.0 | 4.05 | 4.24 | 4.65 | 4.59 | 4.13 |
| Length | | | | | | | |

The Binary Shift technique is similar to the Binary Coding technique for Block 1. However, for Blocks 2 and 3, ones are added to the left, to make them distinguishable and unique, compared to the codes of Block 1. As can be seen from Table 3, the average length for Binary Shift code in this example (4.59) is larger than that of Huffman code in this example (4.05).

The B-code technique has two sections: the Continuation Bit section, called C, and the information bit section. The purpose of C is to separate individual code words, so they alternate between 0 and 1 for each code word in a string and thus are distinguishable and unique. However, remaining aspects of the B-Code technique are similar to the Binary Code technique. The example shown in Table 3 is called a “B2-code”, because 2 information bits are used in the C. As can be seen from Table 3, the average length for B2-code in this example (4.65) is larger than that of Huffman code (in this example 4.05).

The Truncated Huffman technique is similar to Huffman for the most probable source symbols. However, for the rest of the symbols, at the bottom of the table, a fixed-length code is used. As can be seen from Table III, the average length for Truncated Huffman in this example (4.24) is larger than that of Huffman in this example (4.05).

Binary Code is also shown in Table 3 for the purpose of comparison of average lengths. The average length of the Binary Code is 5.0. Note that the “entropy”, i.e. a measure of how much information is actually “in” the data being compressed, for the given example is 4.0. The concept of entropy is well known and thus not discussed in detail herein.

### SUMMARY OF THE INVENTION

A first aspect of the invention is a method for verifying the integrity of data comprising compressing the data in accordance with a predetermined data compression scheme to obtain compressed code, determining at least one compression parameter of the compressed code, transmitting the compressed code, and comparing the at least one parameter determined in said determining step with the corresponding at least one parameter of the compressed code after the transmitting step to determine if the data has been altered.

A second aspect of the invention is a method of verifying the integrity of data comprising, compressing the data in accordance with a predetermined data compression scheme to obtain compressed code, determining a parameter of the compressed code at first time and at a second time using the same algorithm, comparing the parameter determined of the first time with parameter determined at the second time to verify that the data has not been altered.

A third aspect of the invention is a data package comprising compressed code obtained by processing source data in accordance with a predetermined data compression scheme to obtain compressed code, and at least one compression parameter of the compressed code.

### BRIEF DESCRIPTION OF THE DRAWING

The invention is described through a preferred embodiment and the attached drawing in which:

is a flowchart of a method for verifying data integrity in accordance with the preferred embodiment;

is a diagram showing an example of a compression scheme of the preferred embodiment;

is a diagram showing another example of a compression scheme of the preferred embodiment;

is a diagram showing another example of a compression scheme of the preferred embodiment;

is a diagram showing another example of a compression scheme of the preferred embodiment;

is a diagram showing another example of a compression scheme of the preferred embodiment;

is a block diagram of a computer architecture that can be used in accordance with the preferred embodiment; and

is a block diagram of a data package of the preferred embodiment.

### DETAILED DESCRIPTION

The codes of the compression techniques noted above are generated in such a way that they are uniquely decodable. In other words, any string of code symbols can be interpreted in only one way. Therefore, the different variable-length coding methods generally yield different average lengths for given data and the average lengths of code for any specific data are very unique for a given variable-length technique. In addition, these variable-length coding methods are routinely used for the purpose of compression of data for transmission, storage, and other purposes.

Applicant has developed a system and method whereby the average length of the codes, or other compression parameters, of compressed data can be used to verify the integrity of the data. The phrase “compression parameter,” as used herein, refers to any characteristic inherent in the compressed data after being subject to a compression scheme. Therefore, the existing processing overhead used for data compression can be leveraged for data integrity verification. In particular, the data can be coded or compressed using one or more of the variable length coding techniques, such as those techniques discussed above or other variable length coding techniques, and the compression parameter, such as average length, can be calculated for the variable length coding schemes. The values of the compression parameter can then be transmitted along with, or separate from, the compressed data to the receiving device, for verification of the integrity of the data. The compression parameter values can be encrypted and transmitted separately from, or together with, the compressed data.

The data itself can also be encrypted using any encryption method. The data and/or compression parameter values can be compressed or uncompressed, using one or more of these compression techniques, or using other compression techniques not used for the purpose of the data integrity checking. The order or type of compression and encryption can be different for all or some of data and/or compression parameter values. The compressed or uncompressed (or encrypted) forms of the data and/or compression parameter values (or combinations thereof) may be used for data integrity verification by comparing the compression parameter obtained at one time, such as prior to data transmission, with the corresponding parameter at another time, such as after transmission.

As shown in the example of Tables I and II above, to construct the Huffman code table, one uses Huffman Source Reductions, together with the Huffman Code Assignment Procedure. Note that changing a symbol in the original image or data changes the probability and the relative order of that probability in Tables I and II, which in turn, changes the values in the Huffman Source Reductions and the Huffman Code Assignment Procedure. Accordingly, there is a virtually unique resulting Huffman code table, from which average length is obtained, for each set of source data. Since the procedure is non-linear and complex, one cannot easily reconstruct or reverse-engineer a false value for a symbol or code. In fact, for a given situation, this might be mathematically impossible.

Thus, any tampering with original data would change the resulting average length or other parameter. In fact, for a typically sized data file, it may be nearly impossible to reverse-engineer the average length. Specially, if the specific scheme used for the variable length coding is not known to a hacker or intruder, or when multiple variable length coding schemes are used, even if a hacker can reconstruct one of the average lengths, reconstruction of the second (or third, and so on) average length values correctly, without changing the value of the first average length is quite difficult, if not impossible. The greater the number of average lengths used for verification, the more difficult it comes for a hacker to change the data and reconstruct or back-engineer all the average length values without being detected. Schemes for using plural average lengths are described below.

To obtain high accuracy (i.e. obtain almost a unique value, with virtually a one-to-one correspondence to the original source), one should obtain the average length as a real number accurate to as many decimal points as possible (e.g., as much as the available computer power permits). Having greater decimal accuracy reduces the possibility that any two different average lengths will be the same, and the unauthorized reconstruction of average length values become much more difficult.

The preferred embodiment can use any lossless, or other, compression methods in which the original data can be reconstructed with integrity, and from which a parameter can be extracted with a relatively unique value. In other words, unique compression parameters other than average length can be used for integrity verification. For example, with image data, the average pixel intensity, or the weighted average of pixel intensity can be used to verify data integrity.

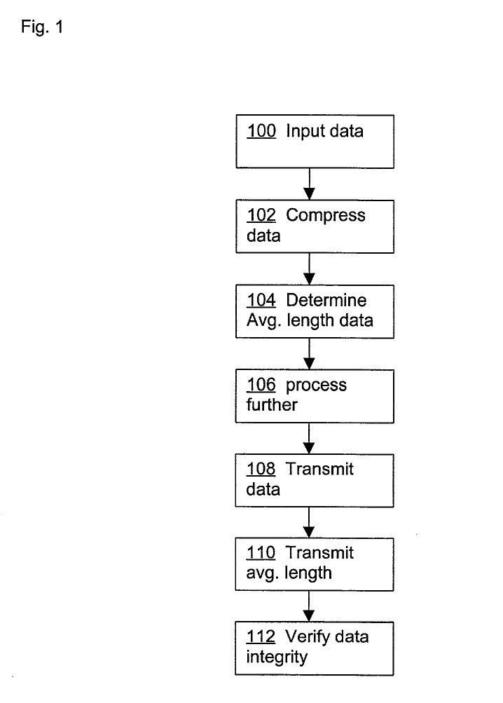

FIG. 1 illustrates a method of verifying data integrity in accordance with a preferred embodiment of the invention. In step 100, the source data is compiled, collected, or otherwise input. In step 102, the source data is compressed, using a variable length compression technique for example, to yield compressed data. Step 102 can include one or more compression algorithms as part of a larger compression scheme as will become apparent below. In step 104, the average length of code corresponding to individual symbols, or other parameters of the compression scheme, is determined by, for example, calculating the average length in the manner described above. In step 106, further processing, such as encryption, further compression, or the like, is accomplished on the compressed data. Examples of such further processing are described in detail below. It will become clear that steps 102, 104, and 106 can be accomplished in their entirety or in part in various chronological orders to effect various compression “schemes”, i.e. processing steps including one or more compression steps and, optionally, other processing.

In step 108, the data is transmitted. The term “transmitted”, as used herein, refers broadly to any communication, movement, processing or accessing of the data. For example, the data can be communicated to another device over a network, such as the Internet. Alternatively, the data can be accessed at a later time from the same device or otherwise subject to processing, such as a request for use, communication, or the like. In step 110, the average length, or other parameter determined in step 104, is also transmitted, in the broad sense described above. In step 112, the integrity of the transmitted data is checked, i.e. verified, based on the compression parameter. For example, the average length can be determined again after transmission and compared to the average length determined in step 104. If the average lengths are identical, the verification step is positive. The recipient can reconstruct the compression scheme to determine the compression parameter and compare it to the original compression parameter.

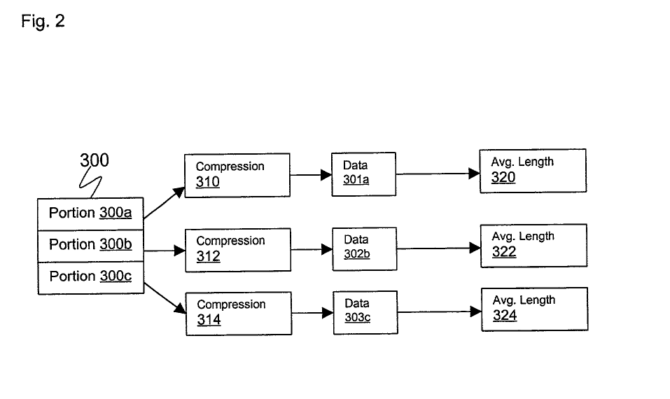

FIGS. 2-4 illustrate examples of the compression and processing, i.e., compression schemes in accordance with the preferred embodiment. Of course, the combination and the order of the steps may be different than those shown in FIGS. 2-4 to achieve any type of compression scheme.

In the example shown in FIG. 2, data 300, such as image data, can be processed into different segments sections, blocks, rows, portions or other data sets 300a, 300b, and 300c. Then each data set 300a, 300b and 300c can be compressed using a different compression technique, compression 316, compression 312, and compression 314, for example, or the same compression technique. The average length or lengths of each portion may be then obtained separately as shown by average length 320, average length 322, and average length 324. These average lengths, or some combination or result of processing thereof, can then be used as parameters for integrity verification. For example, the average or the product of the average lengths can be used as the parameter.

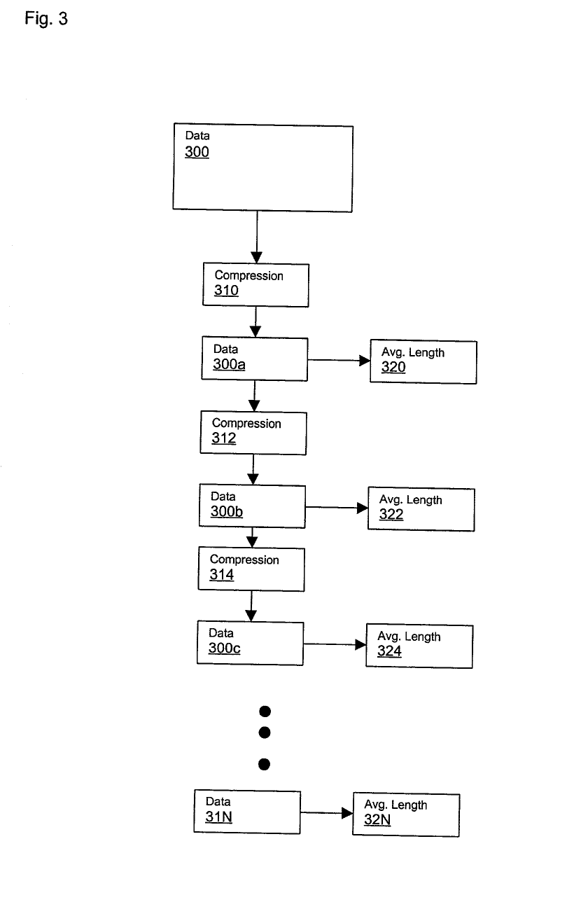

In the example shown in FIG. 3, data 300 can be compressed in its entirety first using compression 310 to obtain compressed data 300a . Then, data 300a is again compressed N times with compression 312 and 314 to step 31N in a serial manner. This can continue for many iterations. The average lengths 320, 322, 324, and 32N of compressed data 300a, 300b, 300c . . . 300n, after each compression step, can be obtained, and used in combination as the compression parameter. Alternatively just average length 31N of the final compressed data can be used as the parameter. It can be seen that compression steps can be cascaded, using the same or different techniques in seriatim.

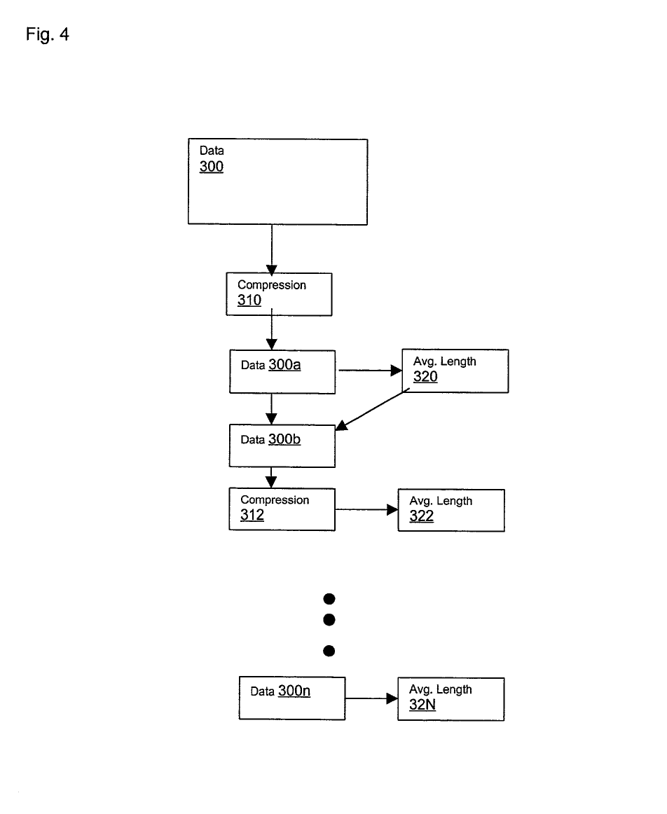

In the example shown in FIG. 4, average length 320 of compressed data 300a can be obtained after compression step 310. Then, compressed data 300a and average length can be combined as modified compression data 300b. Modified compressed data 300b can then be compressed using the same technique or another technique, such as compression 312, and average length 322 can be determined. This method combinations of average lengths and data or compressed data, can be extended to multiple variable length techniques in series (or cascaded), with a predetermined order or randomly generated order of compression techniques to obtain average length 32N. The order of the techniques can be transmitted separately with appropriate security, to make it more difficult to reverse-engineer the process of averaging the averages while permitting the recipient of data to reconstruct the process determine the parameter and thus determine data integrity. The number and order of compression techniques and other processing used in different variable-length techniques can also be maintained in secret, and can be changed in a random or predetermined manner over time.

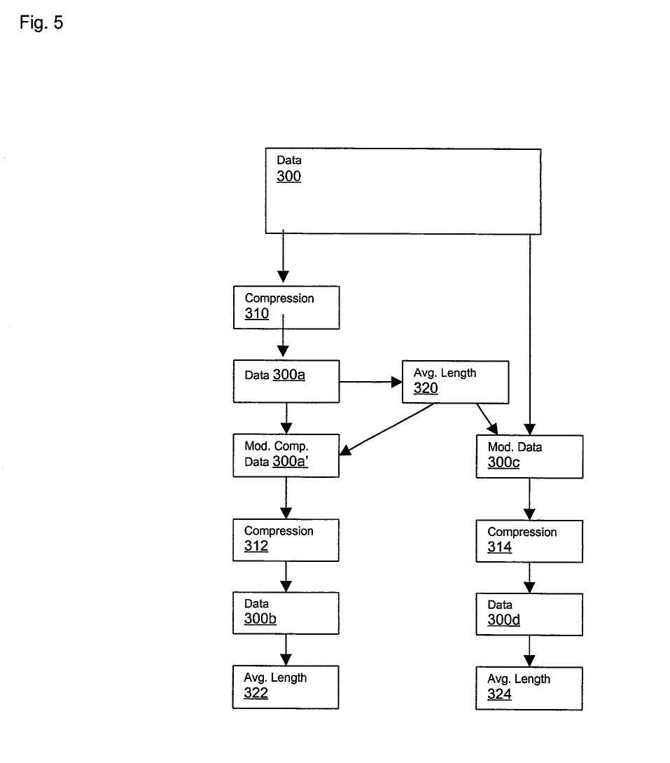

In the example shown in FIG. 5, source data 300 is compressed, using compression algorithm 310, to obtain compressed data 300a. Average length 320 of compressed data 310 is determined and average length 320 is combined with compressed data 310 to obtain modified compressed data 30a', which is then compressed with compression algorithm 312 to obtain compressed data 300b. Average length 320 of data 300a can be combined with data 300 to obtain modified data 300c, which is then compressed with algorithm 314 to obtain data 300d. Average lengths 322 and 324 of data 300b and 300d can be used as compression parameters, alone or in combination, to verify data integrity.

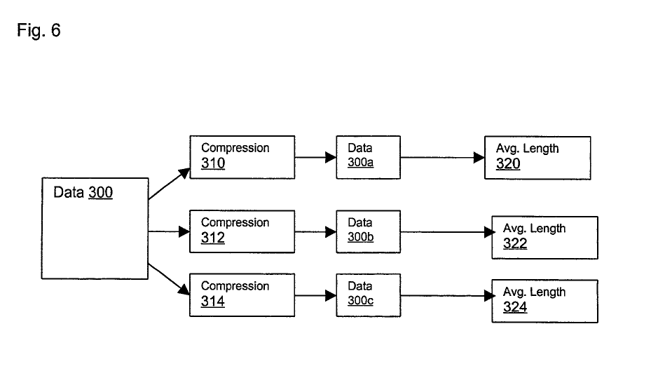

The example of shown FIG. 6 is similar to the example of FIG. 2. However, as illustrated in FIG. 6, source data 300 is compressed, in its entirety, using plural compression algorithms 310, 312 and 314 to obtain 3 sets of compressed data 300a, 300b, and 300c. The average length 320, 322, and 324, respectively, of each set is then determined and used alone, or in combination as compression parameters for verifying data integrity.

The data integrity verification described herein can, for example, be used for watermark removal detection used for copyright protection of an image distributed over Internet. The method described herein can be combined with a PKI security system, or other methodologies such as biometric recognition techniques for verification of the sender or other sources.

Now, consider a special case in which a hacker has replaced all zeros with ones, and all ones with zeros, in an image data file for example. The average length of the hacked image may turn out to be exactly the same as that of the original image, for a given variable length code. However, it should be noted that the image cannot be changed arbitrarily, such as modification of an electronic watermark. Thus, the preferred embodiment is useful with respect to practically significant modifications. Note that this modified image discussed above is a unique image. That is, for a given image, there is only one such modified image which may yield the same average length value as that of the original image. To avoid even this minor problem, one can use a parameter such as average length of average length(s) and/or combinations of average lengths and data, in different orders, in which the value of the average length is itself treated as a data, for the calculation of the next average length of the combination. In this manner, simply replacing zeros and ones with each other cannot generally duplicate or yield the same value for the average length of the average lengths or combination thereof, which means that the values of average lengths in complex schemes are unique or rare, and cannot be easily reproduced. Accordingly, the cascading and combination schemes discussed above will detect even the special case of hacking discussed above.

In another example, for two-dimensional images for example, one can use the run-length encoding, and scan the values of pixels in different directions, such as horizontally, vertically, diagonally, or across at a forty-five degree angle and determine the average length for each scan separately to produce multiple average length values for a given image. With reference to FIG. 2, data sets 300a, 300b, and 300c can each be a segment of the image data scanned in different directions. For example, data set 300a can be data 300 scanned horizontally, data set 300b can be data 300 scanned vertically, and data set 300c can be data 300 scanned diagonally or in another manner. Having multiple average lengths makes it more difficult to reproduce all the average lengths simultaneously. In addition, one can combine these values with the image data. For example, having obtained three average length values from three directions of scanning, one can add the first value to the beginning of the image files, the second in the middle of the file, and the third at the end of the image file. Then, the second average length is calculated from that combination, which makes it even more difficult to reproduce. The method of combination or position of the average length values in the final combination can be in any variation, style, method, or pattern. The only requirement is that the transmitter side (e.g., content creator) and the receiver side (e.g., recipient or user) both have the knowledge of, and use the same method to combine the original data/image with the first set of average length value. For example, the method of combination can be any logical or mathematical operations on pixels or pixel values. In addition, one can process the average length value, such as obtaining the reciprocal or square of that value to make it more difficult to reverse engineer the scheme. Furthermore, as discussed above, the values or combinations can also be encrypted using any encryption method.

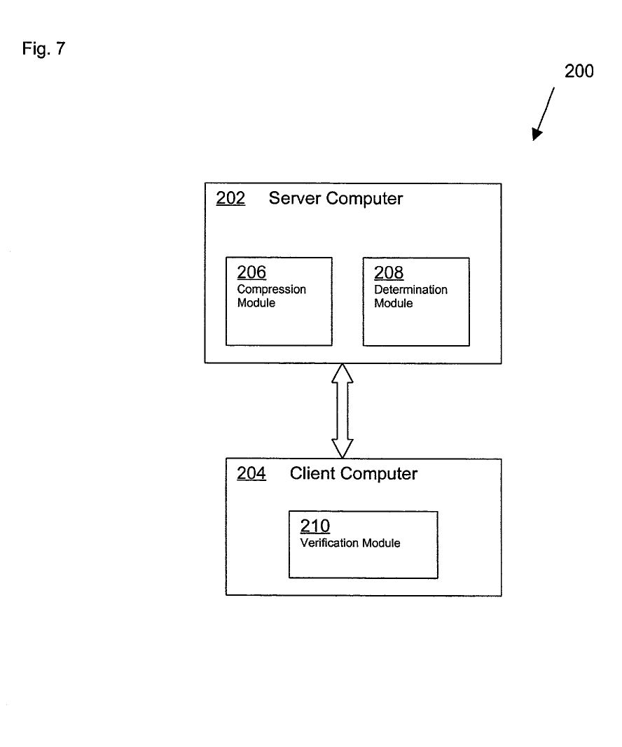

FIG. 7 illustrates computer architecture 200 in accordance with a preferred embodiment. The illustrated embodiment is a client/server configuration. However, any type of computers and/or computer systems can be used in accordance with the invention and the various modules can reside on one or more computers or other devices. As illustrated in FIG. 5, server computer 202 serves as a first device and includes compression module 206 and determination module 208. Compression module 206 includes logic for accomplishing a compression technique, such as a variable length compression algorithm, and any processing logic to permit various compression schemes to be accomplished on data. Determination module 208 includes logic, for determining the average length of code corresponding to symbols in the manner described above. Each of compression module 206 and determination module 208 can be comprised of computer software and/or hardware, or any other processing mechanism, in a known manner.

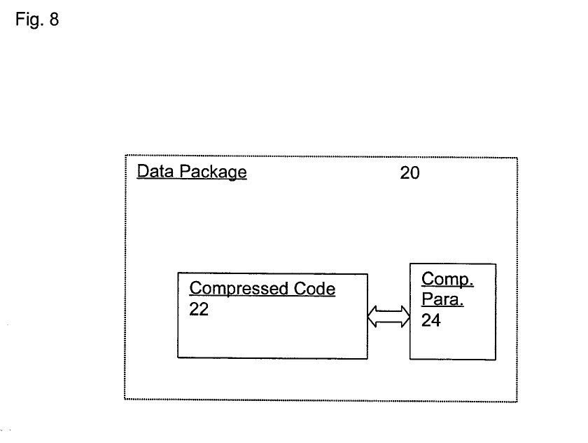

Client computer 204 serves as a second device, is coupled to server computer 202 by communication channel 220, the Internet, a LAN, or the like, and includes verification module 210 having logic for verifying the integrity of data in the manner described above, for example by comparing average lengths before and after transmission. Verification module 210c an be comprised of computer software and/or hardware, or any other processing mechanism. Note that the various modules can be in any type of computer architecture or configuration and can be in the same devices or different devices in any combination. As illustrated in FIG. 8, compressed code 22 and compression parameter 24 can constitute data package 20 which can be used to verify data integrity. Compressed code 22 and compression parameter 24 can be linked, combined in the same file, referenced together, or otherwise encapsulated as a single unit.

This invention can be used for any system, device, in which data integrity is to be enforced. The compression schemes can be include any compression technique, other processing or combinations thereof. Further any parameter or parameters of a compression scheme can be used for verification of data integrity. The parameter values can be inserted into the data at any place and in any manner. The parameters can be processed using any mathematical or logical process prior to being inserted in the data or transmitted. The plural parameters can be combined in any manner through any mathematical process, logical process, or other manipulation. An alarm or other warning can be effected if the compression parameter has changed.

The invention has been described through a preferred embodiment. However, various modifications can be made without departing from the scope of the invention as defined by the appended claims.

What is claimed:

1. A method for verifying the integrity of data comprising:
compressing the data in accordance with a predetermined data compression scheme to obtain compressed code;
determining at least one compression parameter of the compressed code;
transmitting the compressed code; and
comparing the at least one parameter determined in said determining step with the corresponding at least one parameter of the compressed code after said transmitting step to determine if the data has been altered.

2. A method as recited in claim 1, further comprising, generating a warning if the result of said comparing step is that the at least one parameter of the compressed code has changed in value.

3. A method as recited in claim 1, wherein the at least one parameter includes the average symbol length of the compressed code.

4. A method as recited in claim 1, further comprising the step of processing the data into plural data sets prior to said compressing step and wherein said compressing step comprises compressing each of the plural data sets to obtain plural sets of compressed code.

5. A method as recited in claim 4, wherein the data is image data and said processing step comprises scanning the data in different directions to obtain a data set for each of the directions.

6. A method as recited in claim 1, further comprising processing the data into plural data sets prior to said compressing step and wherein said compressing step comprises compressing each of the plural data sets using a different respective compression algorithm to obtain plural sets of compressed code.

7. A method as recited in claim 6 wherein said determining step comprises determining the average symbol length of each of the sets of compressed code.

8. A method as recited in claim 4, wherein said determining step comprises calculating the average symbol length for each of the sets of compressed code.

9. A method as recited in claim 7, wherein said determining step further comprises, determining an average of the average symbol lengths.

10. A method as recited in claim 7, wherein said determining step comprises combining the average symbol lengths to determine a combined compression parameter.

11. A method as recited in claim 11, wherein said combining step comprises applying at least one of a mathematical and logical process to the average symbol lengths.

12. A method as recited in claim 1, further comprising encrypting at least one of the compressed code and the compression parameter.

13. A method as recited in claim 1, wherein said compressing step comprises compressing the data plural times with plural respective compression algorithms to obtain plural sets of compressed code.

14. A method as recited in claim 13, wherein said determining step comprises determining the average length of each of the sets of compressed code.

15. A method as recited in claim 1, wherein said compressing step further comprises determining the average length of the compressed code combining the average length with the compressed code to obtain modified compressed code, and combining the average length with data to obtain modified data, and wherein said determining step comprises determining a compression parameter of each of the modified compressed code and the modified data.

16. A method of verifying the integrity of data comprising:
compressing the data in accordance with a predetermined data compression scheme to obtain compressed code;
determining a parameter of the compressed code at first time and at a second time using the same algorithm;
comparing the parameter determined of the first time with parameter determined at the second time to verify that the data has not been altered.

17. A method as recited in claim 16, wherein the parameter comprises the average symbol length of the compressed code.

18. A method as recited in claim 16, further comprising the step of processing the data into plural data sets prior to said compressing step and wherein said compressing step comprises compressing each of the plural data sets to obtain plural sets of compressed code.

19. A method as recited in claim 18, wherein the data is image data and said processing step comprises scanning the data in different directions to obtain a data set for each of the directions.

20. A method as recited in claim 16, further comprising processing the data into plural data sets prior to said compressing step and wherein said compressing step comprises compressing each of the plural data sets using a different respective compression algorithm to obtain plural sets of compressed code.

21. A method as recited in claim 20, wherein said determining step comprises determining the average length of each of the sets of compressed code.

22. A method as recited in claim 18, wherein said determining step comprises calculating the average symbol length for each of the sets of compressed code.

23. A method as recited in claim 22, wherein said determining step further comprises, determining an average of the average symbol lengths.

24. A method as recited in claim 22, wherein said determining step comprises combining the average symbol lengths to determine a combined compression parameter.

25. A method as recited in claim 24, wherein said combining step comprises applying at least one of a mathematical and logical process to the average symbol lengths.

26. A method as recited in claim 16, further comprising encrypting at least one of the compressed code and the compression parameter.

27. A method as recited in claim 16, wherein said compressing step comprises compressing the data plural times with plural respective compression algorithms to obtain plural sets of compressed code.

28. A method as recited in claim 27, wherein said determining step comprises determining the average length of each of the sets of compressed code.

29. A method as recited in claim 16, wherein said compressing step further comprises determining the average length of the compressed code combining the average length with the compressed code to obtain modified compressed code, combining the average length with data to obtain modified data, and wherein said determining step comprises determining a compression parameter of each of the modified compressed code and the modified data.

30. A data package adapted to be used in a system for verifying the integrity of source data, said data package comprising:
compressed code obtained by compressing source data in accordance with a predetermined data compression scheme to obtain compressed code; and
at least one compression parameter of the compressed code.

31. The data package as recited in claim 30, wherein the at least one compressing parameter includes the average symbol length of the compressed code.

32. A data package as recited in claim 31, wherein at least one of the compressed code and the compression parameter are encrypted.

33. A data package as recited in claim 31, wherein the compressed code and the compression parameter are encapsulated.

34. A data package as recited in claim 33, wherein the compression parameter is inserted into the compressed code.
